(19) United States
(12) Patent Application Publication
(10) Pub. No.: US 2002/0018565 A1
(43) Pub. Date: Feb. 14, 2002

(54) Configurable encryption for access control of digital content

(76) Inventors: Maximilian Luttrell, San Francisco, CA (US); Mike Severa, Pasadena, CA (US); Jiangtao Wen, La Jolla, CA (US); Wenjun Zeng, San Diego, CA (US)

Correspondence Address: PACKETVIDEO CORPORATION, 4820 EASTGATE MALL, SAN DIEGO, CA, 92121, US

(21) Appl. No.: 09/905,305

(22) Filed: Jul. 13, 2001

Related U.S. Application Data
(60) Provisional application No. 60/218,096, filed on Jul. 13, 2000.

(51) Int. Cl. H04L 9/00

(52) U.S. Cl. 380/217; 380/42

(57) ABSTRACT

A compliance preserving method and device for access control of a standard compliant multimedia bitstream. The access control method performs selective encryption on information in the bitstream and then remaps the encrypted information into the bitstream, to provide a multimedia bitstream that is accessible to users with a proper key. The method can be applied to both error resilient mode and non-error resilient mode bitstreams. Additionally, the selective encryption method can be used with variable length code (VLC) codewords or fixed length code (FLC) codewords of a bitstream.

The present invention claims priority benefit from co-pending U.S. Provisional Application, Ser. No. 60/218,096, entitled, “Error Resilient Access Control of Standardized Error Resilient Mode Video Bitstreams,” which is incorporated herein by reference in its entirety.

### BACKGROUND OF THE INVENTION

Encryption of content in a compressed domain can be achieved in various ways, the simplest of which is to encrypt the entire compressed media bitstream with a cipher. Only the authorized user has access to the key and is able to decrypt the cipher text and view the content. To reduce the amount of processing overhead, for example in an MPEG format bitstream, methods for selective encryption of the MPEG compressed video data have been proposed. Some of these methods, as described by L. Tang, “Methods for encrypting and decrypting MPEG video data efficiently,” Proc. The Fourth ACM International Multimedia Conference (ACM Multimedia'96), pp. 219-229, 1996; C. Shi et al., “MPEG video encryption in real-time using secret key cryptography,” http://Purdue.edu/homes/bb/security99.ps.; and W. Zeng et al., “Efficient frequency domain video scrambling for content access control,” Proc. ACM Multimedia'99, pp. 285-294, Nov. 1999, could result in an encrypted bitstream that is still format compliant. For example, the method of Tang used random permutation order as opposed to the normal zigzag order for run-length coding. In addition, he also proposed encrypting the DCs using DES. The scheme is very lightweight and is fully format compliant, but it incurs a coding bit overhead of up to 50%, and is subject to plain-text attack, and cipher-text attack (by making use of frequency statistics). Shi et al. proposed encrypting selected sign bits of the DCT coefficients and sign bits of MV using DES. This scheme is very lightweight, and incurs no bit overhead. But it may not be very secure. It has also been shown by A. S. Tosun et al., “A light-weight mechanism for securing multi-layer video streams,” Proc. IEEE Inter. Conf. on Information Technology: Coding and Computing, pp. 157-161, April 2001, that the I frames can be made somewhat comprehensible by using the attack of setting all sign bits to positive. Zeng et al. proposed a selective scrambling scheme where MVs and DCT coefficients are spatially shuffled in the transform domain, prior to entropy coding. Some bit overhead (4-5%) has been observed. There are also some layered approaches as described by Tosun et al., as well as J. Meyer et al., “Security mechanisms for multimedia data with the example MPEG-1 video,” http://www.cs.tuberlin.de/phade/phade/secmpeg.html, 1995, that do not result in a format-compliant encrypted bitstream. Some additional header overhead is usually incurred in these approaches.

There are also some transport layer selective encryption schemes where the compressed bit streams are encrypted when they are transported over the network. For example, in U.S. Pat. No. 5,805,700 issued to Nardone et al., selective encryption of basic transfer units (BTUs) (e.g., data packet for a disk sector for DVD, or transport packet for digital satellite service) is proposed. A BTU that contains a picture start code of an I frame, and some of the P or B frames is selected for encryption. A fraction of the BTUs of the I-frames and/or the P-frames is also encrypted. The encrypted data in these cases is not format-compliant.

The importance and value of maintaining standard compliance has not been generally recognized in the prior arts, except for in J. Meyer et al. and Tosun et al., where the value of the syntax is preserved in a way that is outside the scope of syntax (i.e. syntax compliance was not maintained after encryption, but syntactical logic units were grouped through differential packetization), and in Zeng et al. where features such as processing overhead, data selectivity, error resiliency, different levels of security, transcodability and applicability of signal processing without decryption were discussed to some extent in a joint encryption and compression framework.

Recently, demands for multimedia communications over a large variety of networks have resulted in the introduction of international standards for audio/video compression and multiplexing. Many proprietary formats for compression and multiplexing have also gained market recognition. Many of these international standards and proprietary formats were designed with provisions for requirements other than transmission efficiency. At the same time, as computers and computer networks become faster and more ubiquitous and publication and distribution of multimedia content via the Internet (wired or wireless) becomes more widespread, the ability to securely transmit such compressed multimedia bit streams becomes increasingly important.

One critical component of a secure multimedia content production/transmission/consumption system is conditional access or access control. It is often achieved by encrypting the content bitstream and providing the key (via a secure key delivery and management system) only to authorized and authenticated users. Due to the nature of the compressed multimedia content bit stream and of the networks over which content is transmitted and the devices that are used for content playback (e.g. PCs, set-top-boxes, PDAs, smart phones), direct encryption of multimedia content bitstreams poses problems in various transmission and playback scenarios. In addition, the differences in the trust level, capability of playback terminals, value of content and expected shelf life also impact the level of security that need to be achieved in the end to end system, from the author of the content to the end consumer. For example, a digital master of a new “Star Wars” episode should be protected with a much higher level of security than regular home video. Given that all these factors need to be taken into account when designing an optimal end-to-end solution for secure delivery and consumption of digital content, it is clear that there exists no “one-size-fits-all” solution for access control. Rather, the access control system, including key delivery/management and content encryption, should be able to be configured, so that it fits the combination of parameters best.

In addition, between production and consumption, multimedia content often undergoes various stages/types/forms of signal processing by various parties. In this food chain, encryption for access control could potentially be performed at almost all possible stages, including, e.g. production, delivery, content congregation, indexing, and consumption, and by different parities. It is highly desirable if various common signal processing (e.g. watermarking, random access, statistical multiplexing) can be performed on encrypted content directly without having to decrypt, process and re-encrypt the content. The latter approach not only increases computational and memory overhead, it also introduces significant security problems, as more links in the chain that have to be trusted with keys and clear content.

Unfortunately, flexible configurability of security levels, capability of performing signal processing after encryption, error resiliency and security itself have conflicting requirements. Thus, there exists a need for performing access control on compressed digital multimedia content that is secure, error resilient, and allows the capability of performing common signal processing directly on the encrypted content. Additionally, the security and complexity of the encryption must also be configurable.

### SUMMARY OF THE INVENTION

The current invention is focused on a unique compliance-preserving encryption method of variable length coded fields in compressed bitstreams. The present invention provides a method of encrypting content bitstream for access control of digital multimedia content. The invention satisfies the previously unsolved conflicting requirements by maintaining a configurable level of compliance to format (syntax) of the original un-encrypted content and thereby leveraging structures in the compressed multimedia content that already provide network friendliness, the capability of signal processing and error resiliency.

In the present invention, the security issue is addressed by using ciphers of the implementers' choice that are known to be secure. As such, the invention is not a new encryption algorithm, but a configurable framework of applying proven encryption algorithms specifically to digital media content. It is aimed to achieve the best trade off for security, delivery, and consumption of multimedia content over various network, protocols, bandwidth, and platforms for a large variety of content and media types through configurability.

In one embodiment according to principles of the present invention, a method for error resilient access control utilizing the MPEG-4 error resilient mode syntax (defined by the ISO/IEC/SC29/WG11, “Information technology—Coding of audio-visual objects-Part 2: Visual ISO/IEC 14496-2”, International Standards Organization, 11/98), transmitted over error-prone channels is provided. The method encrypts only motion information in the header partition in a video packet following MPEG-4 error resilience mode syntax. This is suitable for access control because header information is critical to the correct interpretation of compressed video data. The quality of the processed bitstream will be unpleasant enough to deprive a possible eavesdropper from using the bitstream for entertainment purposes without the proper key. From an error resilience perspective, because the structure of the header partition, and that the header partition is sometimes protected more heavily than other partitions, error resilience can be achieved by leveraging existing error resilience technologies designed for unencrypted MPEG-4 video, such as unequal error protection and smart decoding.

The encryption of header information in this embodiment is done by extracting variable length coded motion information, mapping codewords to fixed length indices, encrypting indices with a pre-selected cipher and finally remapping the encrypted indices to motion information that is a standard-compliant header partition to achieve both access control and error resiliency. When the proper cipher and the associated operating mode are chosen, security is maintained after such encryption.

Furthermore, when error resilience is not an issue, the security requirements for the content is low, and one is concerned with secure access control with low complexity and computational and bandwidth overhead, another embodiment of the present invention provides a method in which information is manipulated directly from the compressed bitstream without mapping into indices. In this embodiment, critical information is extracted from the compressed video bitstream that is coded with fixed length codes, e.g. DC coefficients for INTRA blocks, signs of non-zero DCT coefficients, signs of motion vectors, reference selection code for the enhancement layer (in certain scalability levels and profiles) and quantization parameter. The extracted bits are then passed through a cipher and the resulting bits (which are of the same length as the original bits) are put back into the original positions.

If warranted by security requirements and the value of the content to be secured, one can also encrypt both the motion information and the texture information, either interleaved and encrypted jointly with one cipher, or separately and encrypted with different ciphers.

Following the same strategy, other embodiments of the invention can be designed by configuring the tools in this invention in the most appropriate way for the particular media type, application, platform, and content.

### BRIEF DESCRIPTION OF THE DRAWINGS

The current invention provides a configurable encryption method for securing digital media content for delivery over communication networks and playback on various devices with varying computational power. Other features and advantages of the invention will be understood and appreciated by those of ordinary skill in the art upon consideration of the following detailed description, appended claims and accompanying drawings of preferred embodiments, where

FIG. 1 is a diagrammatic representation illustrating the breakdown of an exemplary video bitstream used according to principles of the present invention;

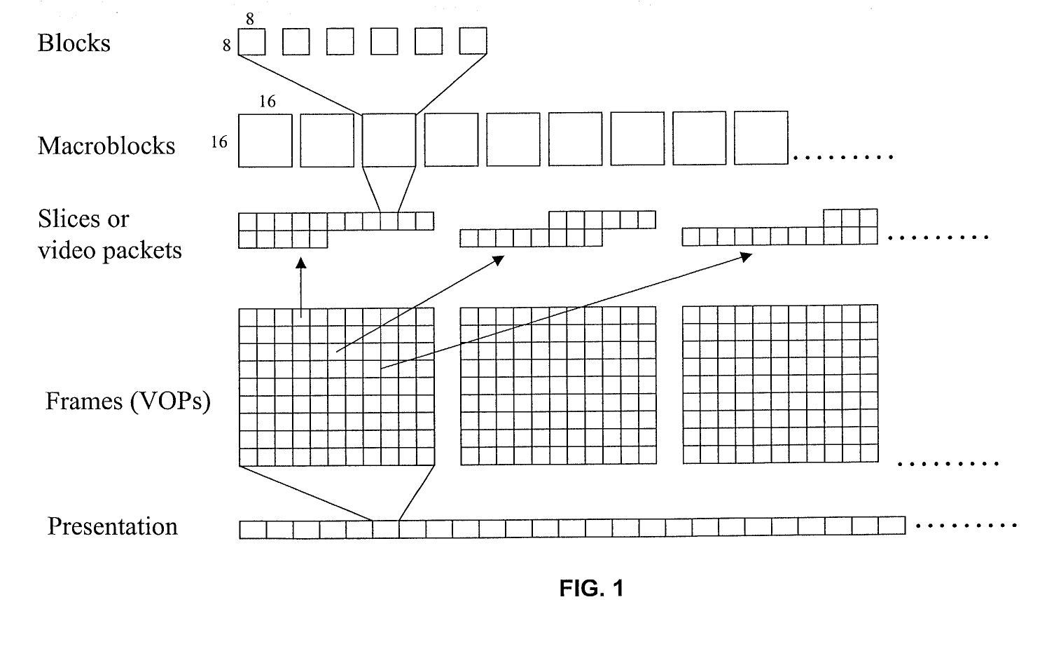

FIGS. 2A and 2B are examples of partial code tables which can be used in accordance with the present invention;

FIG. 3 is a flowchart illustrating an implementation of error resilient access control in a standardized video bit stream according to principles of the present invention;

FIGS. 4A-4E show diagrammatic representations of the steps in FIG. 3 being carried out on a bitstream;

FIG. 5 is a flowchart illustrating an implementation of non-error resilient access control in a standardized video bit stream; and

FIGS. 6A-6C show diagrammatic representations of the steps in FIG. 5 being carried out on a bitstream.

### DETAILED DESCRIPTION OF THE INVENTION

The current invention provides tools that could be configured in various ways to achieve the best tradeoff between security, complexity, flexibility, error resiliency, network friendliness and various other requirements mentioned in the introduction.

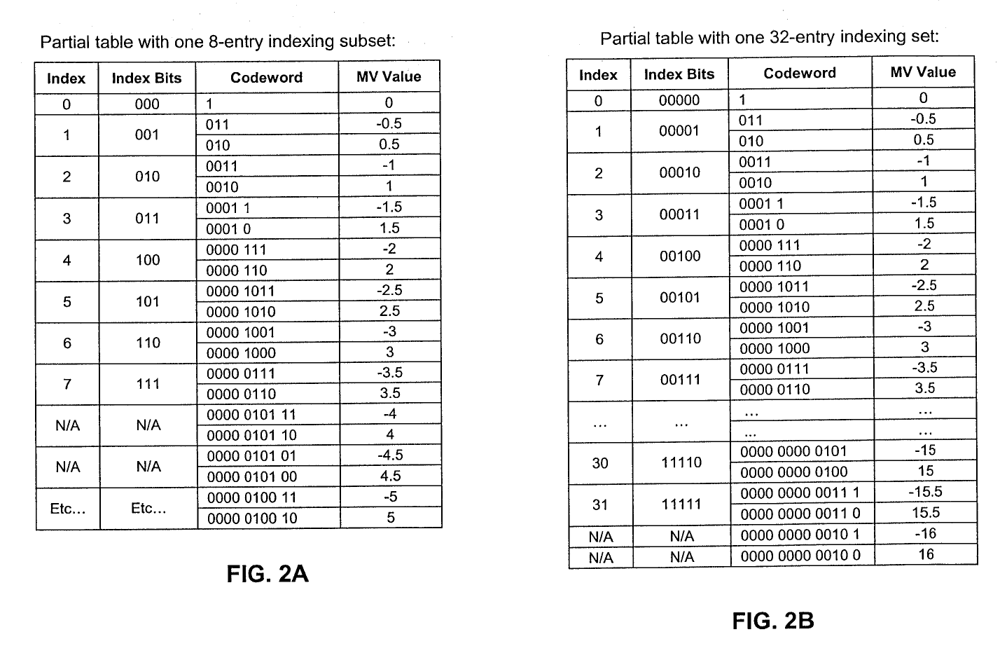

One critical part of the present invention is a way to encrypt a concatenation of codewords from a VLC code table, such that it is secure, and the bitstream after encryption still contains a valid concatenation of codewords with exactly the same number of codewords from the same code table. FIGS. 2A and 2B show examples of partial code tables defined in the MPEG standard. This technique, when applied appropriately to compressed multimedia content in conjunction with other tools described in the document, achieves security while maintaining compliance to the syntax.

The length of the index is determined as follows: a subset of code words in the code table is first identified; with the number of the codewords in the subset being the n-th power of 2. Then each index is assigned n-bits. The subset should usually be the most “probable” subset of the original code table to achieve optimal security, meaning that no other subset of the same number of code words from the code table will have a higher combined probability of occurrence than the subset chosen. It is also recognized that sometimes to achieve the best security, complexity and overhead tradeoff, one may not want to pick the largest subset of the original code table with a power-of-2 number of code words. When the a priori probabilities are not known, one should pick the subset of codewords of the shortest code lengths, i.e., select the shortest codeword, then the second shortest, and so on, until the desired number of codewords has been reached. Note that the ordering of the code words in the subset does not matter, so long as both the encryptor and the decryptor have the same ordering (i.e. the shortest codeword in a 8-codeword subset could have any index between 000 and 111).

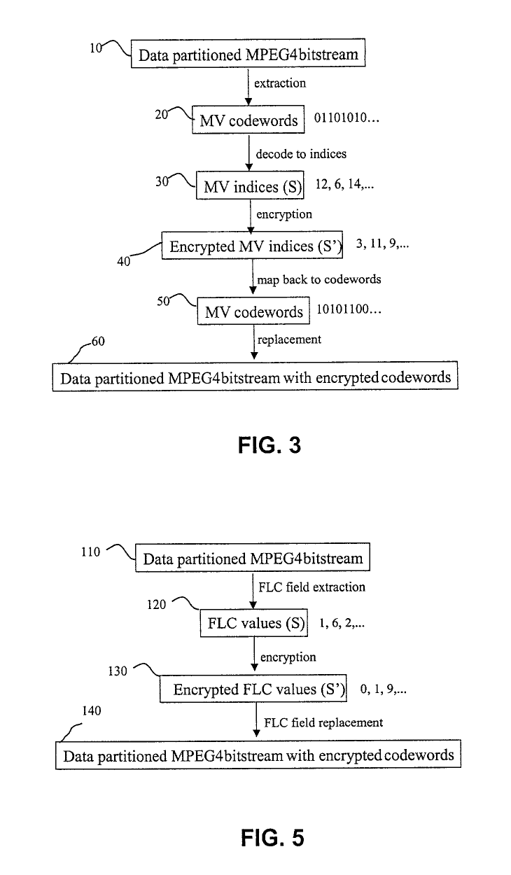

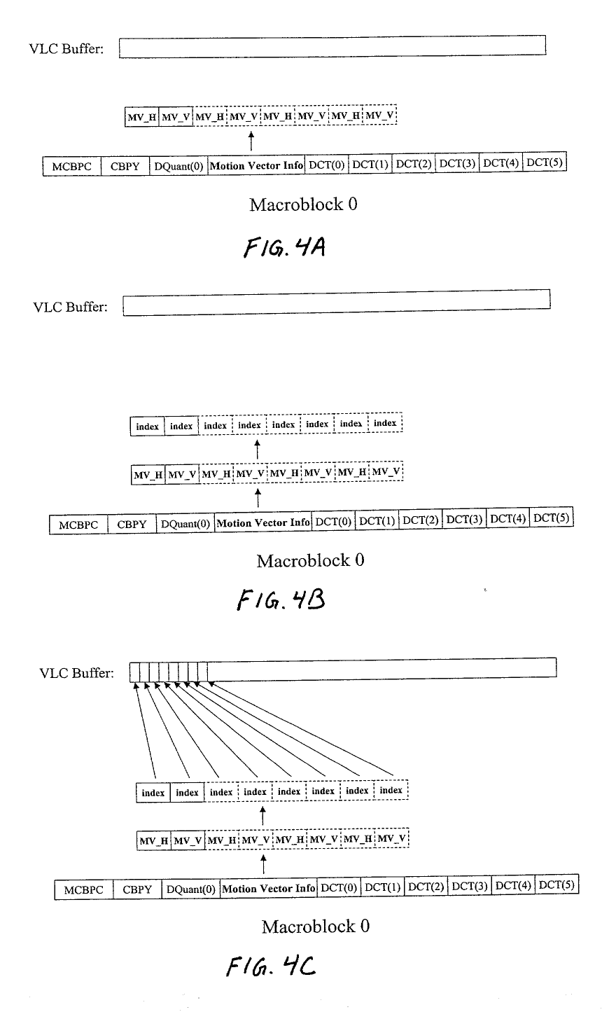

Referring to FIGS. 3 and 4A-4E, the technique works as follows for a VLC table with N codewords, where N is the n-th power of two (i.e. 2ⁿ=N). Before encryption, a fixed length n-bit index is first assigned to each codeword in the VLC code table. Then after a concatenation C of codewords from the code table is obtained, a bit string S is constructed by concatenating the indices for codewords contained in C (FIG. 4C). Here, one of ordinary skill in the art would recognize that for digital content, because different types of fields are often interleaved, obtaining concatenations of codewords from the same table may involve parsing the bitstream and constructing concatenations of codewords not contiguously present in the bitstream. S is next encrypted with a chosen secure cipher operating in a chosen mode deemed suitable for the content, application, network and device (FIG. 4D). The string of bits after encrypting S, denoted S′, is then mapped back to codewords in the code table (which can form a concatenation of C′) using the same index-to-code-book-entry map. Codewords from the C′ are then put back into the content bitstream in place of the original codewords in C (FIG. 4E).

In decrypting encrypted VLC codewords encrypted using the above technique, the exact opposite operation is carried out, i.e. the encrypted codeword concatenation C′ is obtained by parsing the bit stream and extracting the codewords. These are then mapped to an encrypted index sequence, S′, which is decrypted to index sequence S, and then mapped to codeword concatenation C, and from this concatenation the original codewords are put back into the content bitstream.

Note that to guarantee that C′ has exactly the same number of codewords as C, the cipher should be chosen so that the length of its output (in bits) is identical to the length of its input. Padding with “dummy” data for block ciphers should usually be avoided, unless warranted by the particular application, for example, in which the number of encrypted codewords does not have to be identical to the number of codewords before encryption.

Because of the randomizing effect of ciphers, the length (in bits) of C′ will be different from the length of C, with the length of C′ on average longer, even though both C′ and C contain the same integer number of codewords from the same code table.

When the total number of codewords in the VLC table T, N, is not a power of 2, the table can be divided into non-overlapping subsets of T, T₁, T₂, . . , Tₘ, with N₁, N₂, . . , Nₘ codewords respectively (different Nⱼ's do not have to take on different values), each being a power of 2. Then when code word concatenation C is obtained, it is mapped to an index concatenation S by concatenating indices of codewords into the corresponding subset Tᵢ to which the codeword belongs. For example, if in C, a codeword X from Tᵢ with 8 codewords in followed by a codeword Y from Tⱼ with 4 codewords, then the corresponding index concatenation in S will be the 3-bit index for codeword X in Tᵢ, followed by the 2-bit index for Y in Tⱼ. Then the same encryption can be carried out on S, and the encrypted index sequence S′ can be divided in a similar way and mapped to codewords.

It should be noted however, when this approach is taken, the design of the sub-tables should be carefully carried out so that the size of each subset is sufficient for security. The design of the sub-sets also impacts the difference in length (in bits) between C′ and C. As a general guide line from the security perspective, the largest subset of the original table should consists of the most likely subset of codewords, so that the effect of subset indexing is least “invisible” to an attacker.

The above technique has several extensions. The first one is encrypting fixed length codes in the content bitstream. Because fixed length codes are just a special case of variable length codes, the exact same approach above can be carried out. However, if the code table a total number of codewords that is a power of 2, then each codeword itself can be regarded as the index to the codeword, and the codeword concatenation C and the index concatenation S become identical. In this case, therefore the “map to index” and “map back to codeword” steps can be skipped. However, when 1) the total number of codewords is not a power of 2; or 2) if one only intends to encrypt a subset (with a power of 2 number of codewords); or 3) if one desires to use indices for FLC codewords that are different from the codewords themselves, the mapping to index and back steps can not be skipped.

The second extension to the technique is, when forming the concatenation and indexing codewords, one might also interleave codewords from different “logical units” of the original media content bitstream when constructing C, and/or interleave indices for different fields using different tables when constructing S. One possible example of this extension is for MPEG-4 video, one may want to encrypt INTRA macroblock (MB) DC information, together with INTER and INTRA block DCT sign information and INTER MB motion vector (MV) information. To do this, one may use a 5-bit index for DC, the 1-bit DCT sign as index to itself, and a 6-bit index for MV to index the codewords for these fields separately. The indices can be interleaved in the order in which the un-encrypted codewords show up in the bit stream. After encryption, the index sequence will be “broken” up into indices for different fields (e.g. in the previous example, 5-bit index for DC, followed by 1-bit indices for DCT signs, followed by 6-bit indices for MV), and then mapped into codewords and put back into the content bitstream. As an alternative to indexing codewords from different field separately, one can also produce a “master” code table by exhausting all valid combinations of codewords from tables for individual fields, to which indices can be determined for all combinations of the selected fields.

The above technique, including the extensions, can be used with any media type (video, audio, image, graphics, text, data) to achieve the optimal tradeoff between application requirements and security. In designing the proper system for a given media type, syntax, application, platform, media value, and other requirements, one should carefully choose the fields to be encrypted, the way fields are concatenated, and proper cipher.

In accordance with principles of the present invention, a particular embodiment of the current invention leverages error resilience provisions in MPEG-4 video coding standard with data partitioning to achieve error resilience of the encrypted MPEG-4 video content bitstream.

The MPEG-4 standard defines an error resilient operating mode that uses data partitioning and resynchronization markers. In this mode, the macroblock (MB) coding type information and motion vector (MV) information (header information) is partitioned from the texture information for each packet. A uniquely designed motion marker separates the header partition and texture information. Packets are delimited by a byte-aligned unique bit pattern called the resynchronization marker, and fixed-length index-to-first MB information is put at the beginning of each packet to provide additional error recovery and error detection capability. The motion markers and resynchronization markers are designed so that they can be searched without parsing the bitstream.

This syntax will prevent bit errors that occur in less important information fields (e.g. texture) from propagating and “corrupting” more important information types, namely data in the header and motion partition. This data partitioned structure enables easy priority packetization and transmission of important header and motion information, as well as soft decoding on header information. Data partitioning also enables easy unequal error protection for information with different levels of importance.

In this embodiment of the present invention scrambles only the motion vector information in the header partition of packets following the MPEG-4 error resilient with data partitioning mode syntax. Referring again to FIG. 3, for each packet of a data partitioned stream, the header partition will be identified by searching for motion markers that separate the header partition and the remainder of the packet. The header partition is parsed and the motion vector codewords 10 are extracted. Then MV codewords are mapped to indices corresponding to the MV code table entries in the MPEG standard 20. There are 65 total MV codewords in the MPEG-4 video standard. Because 65 is not a power of 2, only the shortest 64 codewords in the code table are assigned indices. The remaining codeword in the code table that is not assigned an index, if encountered in the content bitstream, will not be extracted and encrypted, and will be left “in the clear”. The sign of the MVs will be ignored in this step, i.e. a MV of 1 and −1 will result in the same index. Therefore, a 5-bit index is needed for each of the 64 indexed MV codewords.

The 5-bit indices will be concatenated and result in a binary string S 30. The binary string S is then encrypted, which results in a new encrypted string S′ 40. Next, new string S′ is divided into 5-bit segments and each segment is used as an index to the MV table to construct a sequence of MV codewords 50, together with the saved sign information for the corresponding original unencrypted MV codeword. Finally, the resulting codewords will be replaced into the position corresponding to the original MV codeword in the header information partition of the MPEG-4 bitstream 60. The padding at the end of the packet might also need to be adjusted to make sure the total size of the encrypted packet is an integer number of bytes, a requirement of MPEG-4 syntax. The resulting bitstream will be an MPEG-4, error resilient, syntax compliant bitstream. The steps described above should be performed independently for each packet being transmitted to avoid error propagation between packets.

At the decoder end, legitimate users with the proper decryption key can easily reverse the above process and recover the original, correct MV information. Users who do not have the key will not be able to achieve a quality satisfactory for entertainment purposes.

When the bitstream is transmitted over an error prone channel, the decoder can invoke error resilience technologies developed for MPEG-4 video to recover encrypted MPEG-4 video content, and then use the decryption key to obtain the correct MV information. The error resiliency is achieved by forcing the cipher text adhere to the MPEG syntax, thereby making it possible to apply “traditional” MPEG-4 video error resilience and data recovery tools, such as unequal error protection, selective re-transmission and update, and soft decoding. No structure is built on the cipher text itself, and therefore there is no compromise in security. It should be noted that, because the statistics of the codewords after encryption will, in general, be different from those before encryption, some error resilience tools (e.g. soft decoding, which may utilize a priori probability of codewords) may need to be adjusted to reflect this change.

When resiliency to bit errors is not the overwhelming concern, one may also construct an access control system that encrypts the content bit stream following the non-error resilient mode syntax of MPEG-4. For such applications, in addition to encrypting MVs, the following fields from an MPEG-4 video bitstream that are coded with fixed length codes can also be encrypted: INTRA MB DC information, signs of non-zero DCT coefficients and DQUANT information, among others. These latter fields only apply to a non-error resilient environment because they are often deemed less important to the quality of reconstructed video and therefore are offered a lower level of error protection in the syntax and thus also during transmission.

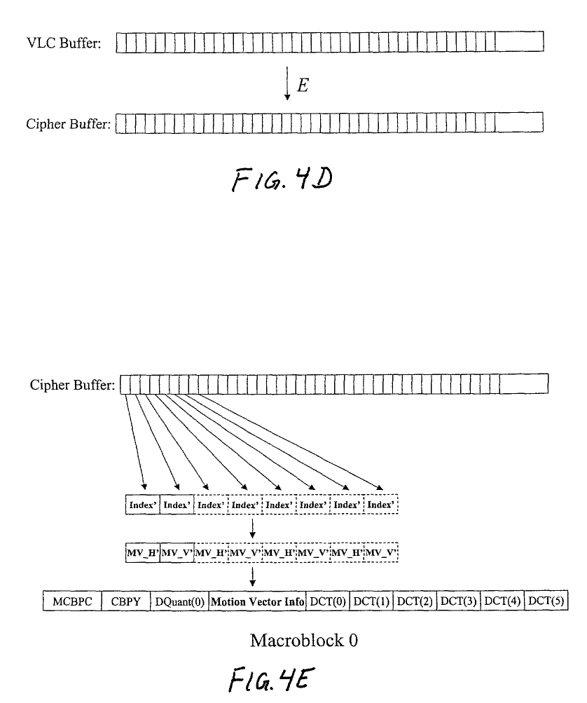

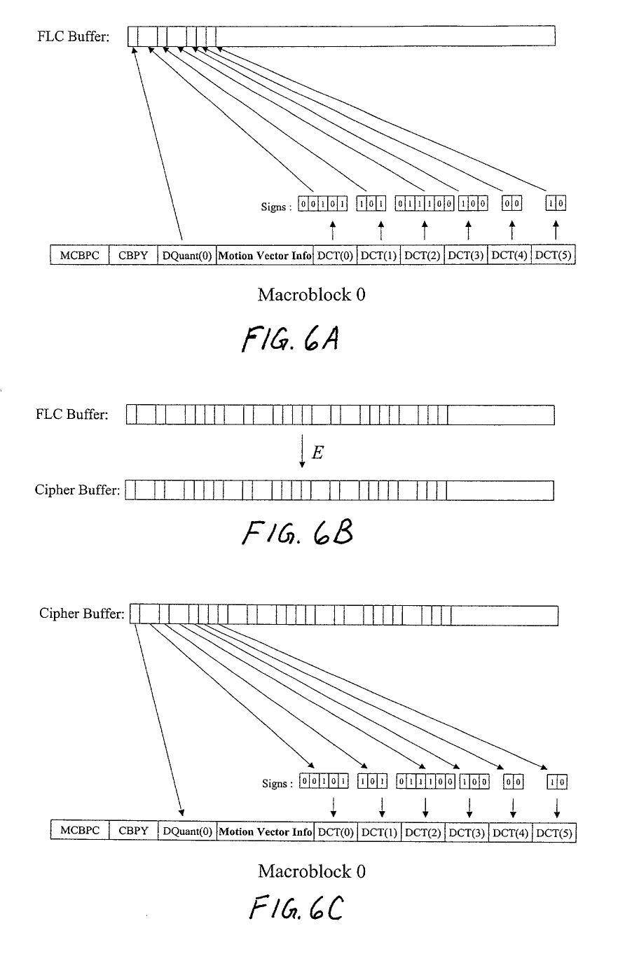

Therefore an additional embodiment designed for non-error resilient access control can also use the method shown in FIG. 3 to encrypt variable length MV information and additionally the method in FIG. 5 for encryption of fixed length INTRA DC, DCT sign, and DQUANT information. According to the flowchart in FIG. 5, and shown in greater detail in FIGS. 6A-6C, fixed-length fields are extracted from the content bit stream 110 and concatenated, resulting in a sequence of fields S 120. This concatenation is encrypted resulting in an encrypted sequence S′ 130. The original FLC codewords in the bit stream are then replaced using the encrypted sequence of codewords 140.

The bitstream resulting from the above encryption maintains compliance to MPEG-4 video syntax. Therefore, the encrypted bitstream can be parsed, processed and served with video compression-aware and Quality of Service (“QOS”) enabled servers, without having to decode, transcode and/or re-encode any data. This relieves individual servers in large-scale networks of decoding and transcoding functions. Further, the requirement that the servers must be “trusted” with unencrypted video bitstreams and keys is removed. All video bitstreams, after encryption and before decryption, are unusable for entertainment purposes. Still further, servers may dynamically adjust bit-rates via priority dropping (e.g. dropping P or B frames or enhancement information). In addition, encrypted video content can be multi-casted whereby only authorized users may access the video content.

A third embodiment of the invention deals with lightweight encryption of content. For applications such as download and playback of video and audio clips on low computational power and memory handheld devices, real time decryption of content may not be feasible, even for low bitrate content. On the other hand, because the low bitrate and therefore low quality, requirement for security is also lower. For such applications, it might be desirable to encrypt only a small portion of the information contained in a compressed content bitstream, such as motion vector information and DCT sign information, using the method of the present invention, thereby enabling copyright protection that is secure enough for the target application, but also feasible on the target platform.

In the above-described 3 embodiments, full compliance to the media compression syntax is preserved after encryption. For some applications, this full, bit level parsing compliance is not required. For example, for high quality content delivered over high-speed networks, the security requirement is high, and therefore one desires to encrypt as much data as possible. However, because the transport layer and packetizer in such networks are sometimes designed to deal with unencrypted content, direct, simplistic encryption of content may cause start code and marker emulation, and create problems for transmission. In this case, yet another embodiment of the present invention is to not encrypt start codes and markers, but only to intelligently encrypt information carrying fields between them. After such encryption, original markers and start codes are still searchable. To prevent emulation in the fields encrypted, a map to index and then to codeword approach can again be pursued, without considering dependencies between fields. For example, when MPEG-4 video compressed using the data partitioned syntax is encrypted, codewords for header information, texture information are encrypted but the resynchronization markers and motion markers will not be encrypted. During encryption, each logical field will be encrypted using the map to index and map back approach. This will result in an encrypted bitstream consists of codewords for the original field delimited by the markers. Because the markers are designed so that they cannot be emulated by concatenations of such codewords, no emulation will be generated after encryption.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. The disclosures and the description herein are purely illustrative and are not intended to be in any sense limiting. It is intended that the scope of the invention be defined by the claims appended hereto and their equivalents.

What is claimed is:

1. A method for access control of a standard compliant multimedia bitstream comprising:
selectively extracting codewords from the bitstream;
encrypting the extracted codewords; and
mapping the encrypted codewords back into the bitstream,
wherein the resulting encrypted bitstream is a secure bitstream accessible by users with a proper key, and has a number of codewords equal to the number of codewords in the bitstream prior to encryption to maintain standard compliance.

2. The method of claim 1, wherein the bitstream has an associated standard defined code table, the codewords each have an assigned fixed length index and the step of encrypting comprises:
concatenating the extracted codewords to form a codeword concatenation C;
mapping the concatenated codewords to indices in the code table;
concatenating the mapped indices to provide a binary bit string S;
encrypting the binary bit string S with a chosen secure cipher to provide an encrypted binary bit string S¹; and
mapping S¹ to codewords in the code table to form an encrypted codeword concatenation C¹.

3. The method of claim 2 wherein the bitstream has a syntax comprising multiple information fields, and the step of selectively extracting codewords comprises extracting variable length codewords from a particular information field.

4. The method of claim 1 wherein the bitstream is an MPEG-4 error resilient, data partitioned bitstream, and the step of selectively extracting codewords comprises extracting motion vector information from the bitstream.

5. The method of claim 1 wherein the bitstream is an MPEG-4 video bitstream, and the step of selectively extracting codewords comprises extracting fixed length coded texture information.

6. A compliance preserving encryption method for a concatenated sequence of variable length code (VLC) codewords, the method comprising:
mapping each VLC codeword to a fixed length index in a code table to obtain a concatenation of fixed length indices;
encrypting the concatenation of fixed length indices with a chosen cipher; and
mapping the encrypted concatenation of indices to VLC codewords in the code table to obtain an encrypted concatenation of VLC codewords,
wherein the number of codewords in the concatenated sequence remains unchanged before and after encryption such that syntax compliance is maintained.

7. A system for access control of a standardized multimedia partitioned bitstream comprising:
an encoder capable of scrambling header information in the partitioned bitstream and remapping the scrambled information into a standard compliant header partition resulting in an encrypted bitstream; and
a decoder having a decryption key capable of recovering proper header information,
wherein the bitstream can be transmitted over an error prone channel and recovered for correct interpretation by an authorized end user.

8. A method for access control of a multimedia bitstream, the method comprising steps of:
accessing a portion of the bitstream to extract selective information;
scrambling the extracted selective information to provide encrypted codewords; and
mapping the encrypted codewords back into the portion of the bitstream,
wherein the resulting bitstream is a secure bitstream accessible by users with a proper key.

9. The method of claim 8, wherein the bitstream is a standardized data partitioned bitstream, and wherein the step of accessing comprises:
accessing a header portion of the bitstream having coding type information and motion vector information (MV codewords), and extracting the MV codewords.

10. The method of claim 9, wherein the scrambling step comprises:
mapping the extracted MV codewords to indices of a standard MV code table for the bitstream;
concatenating the mapped indices to provide a binary bit string S;
encrypting the binary bit string S to provide an encrypted binary bit string S′;
dividing the encrypted binary bit string S′ into equal length segments;
using the equal length codewords to index the standard MV code table to construct a sequence of new MV codewords; and
entropy encoding the new MV codewords.

11. The method of claim 8, wherein the bitstream is an MPEG-4 video bitstream and wherein the extracted selective information is fixed length code (FLC) texture information.
